(19) United States
(12) Patent Application Publication
(10) Pub. No.: US 2019/0255906 A1
(43) Pub. Date: Aug. 22, 2019

(54) HIGH VOLTAGE SYSTEM FOR A TRANSPORT REFRIGERATION UNIT

(71) Applicant: Carrier Corporation, Jupiter, FL (US)

(72) Inventors: Ciara Poolman, Syracuse, NY (US); Robert A. Chopko, Baldwinsville, NY (US)

(21) Appl. No.: 16/316,253

(22) PCT Filed: Jul. 7, 2017
(86) PCT No.: PCT/US2017/041101

§ 371 Date: Jan. 8, 2019

Related U.S. Application Data
(60) Provisional application No. 62/360,135, filed on Jul. 8, 2016.

(51) Int. Cl. B60H 1/00; H02J 7/35; B60W 20/10; H02J 7/14; B60W 10/26; B60W 10/30; B60L 50/50

(52) U.S. Cl. CPC B60H 1/00428; H02J 7/35; B60W 20/10; H02J 7/1423; H02J 7/1438; B60W 10/26; B60H 1/3222; B60L 50/50; B60W 2400/00; B60W 2710/30; B60W 2710/242; B60Y 2400/216; B60Y 2300/91; B60W 10/30

(57) ABSTRACT

A hybrid transport refrigeration unit includes a high voltage battery, at least one high voltage component, a generator, a combustion engine, and a low voltage starter. The high voltage battery includes a plurality of cells connected to the high voltage component. The generator is configured to provide electric power to at least one of the at least one high voltage component. The combustion engine is constructed and arranged to drive the generator. The low voltage starter is electrically connected to at least one of the plurality of cells, and is constructed and arranged to start the combustion engine.

### BACKGROUND

The present disclosure relates to transport refrigeration units and, more particularly, to all-electric transport refrigeration units.

Traditionally, a transport refrigeration unit, such as those utilized to transport cargo via sea, rail, or road, is a cargo truck, tractor trailer or cargo container, generally defining a cargo compartment, and modified to include a refrigeration system located at one end of the truck, trailer, or cargo container. Refrigeration systems typically include a compressor, a condenser, an expansion valve, and an evaporator serially connected by refrigerant lines in a closed refrigerant circuit in accord with known refrigerant vapor compression cycles. A power unit, such as a combustion engine, drives the compressor of the refrigeration unit, and may be diesel powered, natural gas powered, or other type of engine. In many tractor trailer transport refrigeration systems, the compressor is driven by the engine shaft either through a belt drive or by a mechanical shaft-to-shaft link. In other systems, the engine of the refrigeration unit drives a generator that generates electrical power, which in-turn drives the compressor.

With current environmental trends, improvements in transport refrigeration units are desirable particularly toward aspects of environmental impact. With environmentally friendly refrigeration units, improvements in reliability, cost, and weight reduction are also desirable.

### SUMMARY

A hybrid transport refrigeration unit according to one, non-limiting, embodiment of the present disclosure includes a high voltage battery including a plurality of cells; at least one high voltage component electrically connected to the plurality of cells; a generator configured to provide electric power to at least one of the at least one high voltage component; a combustion engine constructed and arranged to drive the generator; and a low voltage starter electrically connected to at least one of the plurality of cells, and constructed and arranged to start the combustion engine.

Additionally to the foregoing embodiment, the combustion engine is a diesel engine.

In the alternative or additionally thereto, in the foregoing embodiment, the combustion engine is a natural gas engine.

In the alternative or additionally thereto, in the foregoing embodiment, the generator is a high voltage generator.

In the alternative or additionally thereto, in the foregoing embodiment, the combustion engine does not include a low voltage alternator.

In the alternative or additionally thereto, in the foregoing embodiment, the at least one high voltage component includes a variable speed condenser motor.

In the alternative or additionally thereto, in the foregoing embodiment, the hybrid transport refrigeration unit includes a step-down transformer electrically oriented between the high voltage battery and the low voltage starter.

In the alternative or additionally thereto, in the foregoing embodiment, the high voltage battery has an electric potential of at least forty-eight (48) volts and the low voltage starter operates at about twelve (12) volts.

In the alternative or additionally thereto, in the foregoing embodiment, the hybrid transport refrigeration unit includes a low voltage microprocessor for unit control.

In the alternative or additionally thereto, in the foregoing embodiment, the low voltage microprocessor is configured to determine when the combustion engine is started.

In the alternative or additionally thereto, in the foregoing embodiment, the hybrid transport refrigeration unit includes a relay configured to electrically isolate the at least one of the plurality of cells from the remaining cells.

In the alternative or additionally thereto, in the foregoing embodiment, the at least one high voltage component is shut down when the combustion engine is being started via the low voltage starter.

In the alternative or additionally thereto, in the foregoing embodiment, the hybrid transport refrigeration unit includes a solar panel configured to electrically charge at least the at least one of the plurality of cells.

In the alternative or additionally thereto, in the foregoing embodiment, the plurality of cells are electrically arranged in series.

In the alternative or additionally thereto, in the foregoing embodiment, the hybrid transport refrigeration unit includes a compressor constructed and arranged to compress a refrigerant; and an electric compressor motor being the at least one high voltage component and configured to drive the compressor, and wherein the generator is configured to provide high voltage electric power to the compressor motor during standard set point conditions and the high voltage battery is configured to supplement the high voltage electric power to the compressor motor during temperature pulldown conditions.

A high voltage system for a transport refrigeration unit having at least one high voltage component, at least one low voltage component, and a combustion engine, the high voltage system according to another, non-limiting, embodiment includes a high voltage battery electrically connected to the at least one high voltage component and the at least one low voltage component; and a high voltage generator configured to at least electrically charge the high voltage battery, and wherein the high voltage generator is driven by the combustion engine.

Additionally to the foregoing embodiment, the high voltage system includes a step-down transformer electrically oriented between the high voltage battery and the at least one low voltage component.

In the alternative or additionally thereto, in the foregoing embodiment, the high voltage battery includes first and second cells arranged in series.

In the alternative or additionally thereto, in the foregoing embodiment, the high voltage system includes a series of open/closed contacts electrically orientated between the first and second cells, between the high voltage battery and the at least one high voltage component, and between the high voltage battery and the at least one low voltage component.

A method of operating a hybrid transport refrigeration unit according to another, non-limiting, embodiment includes running a high voltage component utilizing a high voltage battery; cease running the high voltage component; starting a combustion engine utilizing a low voltage starter that receives electrical power from at least a portion of the high voltage battery; running the combustion engine without an alternator; driving a generator via the combustion engine; and restarting the high voltage component.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a perspective view of a tractor trailer system having a transport refrigeration unit as one, non-limiting, embodiment of the present disclosure;

FIG. 2 is a schematic of the transport refrigeration unit;

FIG. 3 is an electrical schematic of the transport refrigeration unit illustrating power loads;

FIG. 4 is a flow chart of a method of operating the transport refrigeration unit;

FIG. 5 is an electrical schematic of a high voltage system of the transport refrigeration unit;

FIG. 6 is a second embodiment of a high voltage system; and

FIG. 7 is a flow chart of a method of operating the high voltage system.

### DETAILED DESCRIPTION

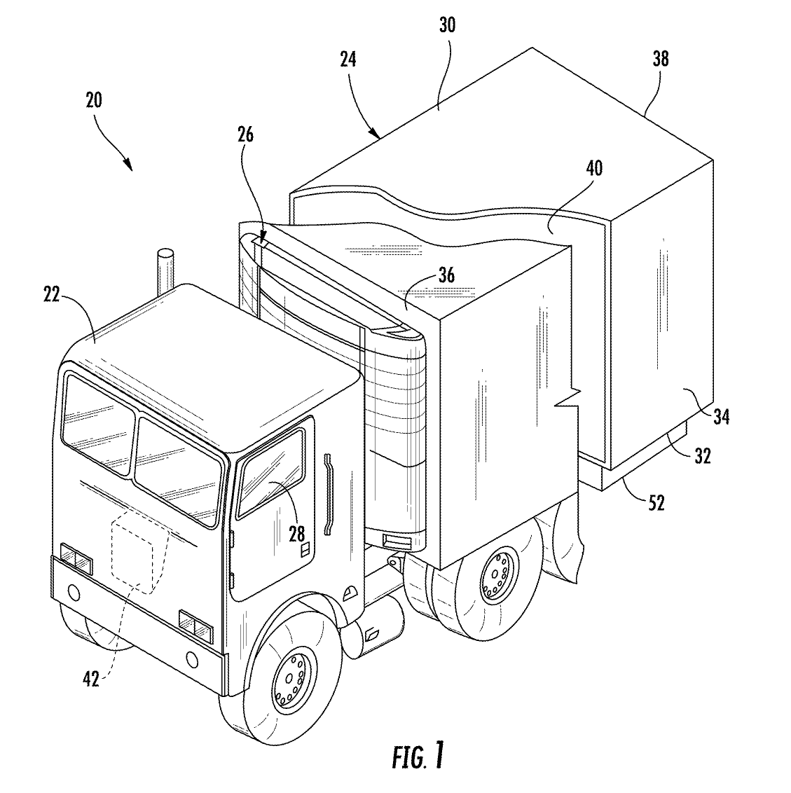

Referring to FIG. 1, a tractor trailer system 20 of the present disclosure is illustrated. The tractor trailer system 20 may include a tractor or truck 22, a trailer 24 and a transport refrigeration unit 26. The tractor 22 may include an operator's compartment or cab 28 and a combustion engine 42 which is part of the powertrain or drive system of the tractor 22. The trailer 24 may be coupled to the tractor 22 and is thus pulled or propelled to desired destinations. The trailer may include a top wall 30, a bottom wall 32 opposed to and space from the top wall 30, two side walls 34 space from and opposed to one-another, and opposing front and rear walls 36, 38 with the front wall 36 being closest to the tractor 22. The trailer 24 may further include doors (not shown) at the rear wall 38, or any other wall. The walls 30, 32, 34, 36, 38 together define the boundaries of a cargo compartment 40. It is contemplated and understood that the cargo compartment may also be divided into two or more smaller compartments for different temperature cargo requirements.

The trailer 24 is generally constructed to store a cargo (not shown) in the compartment 40. The transport refrigeration unit 26 is generally integrated into the trailer 24 and may be mounted to the front wall 36. The cargo is maintained at a desired temperature by cooling of the compartment 40 via the transport refrigeration unit 26 that circulates air into and through the cargo compartment 40 of the trailer 24. It is further contemplated and understood that the transport refrigeration unit 26 may be applied to any transport container and not necessarily those used in tractor trailer systems. Furthermore, the transport container may be a part of the trailer 24 and constructed to be removed from a framework and wheels (not shown) of the trailer 24 for alternative shipping means (e.g., marine, rail, flight, and others).

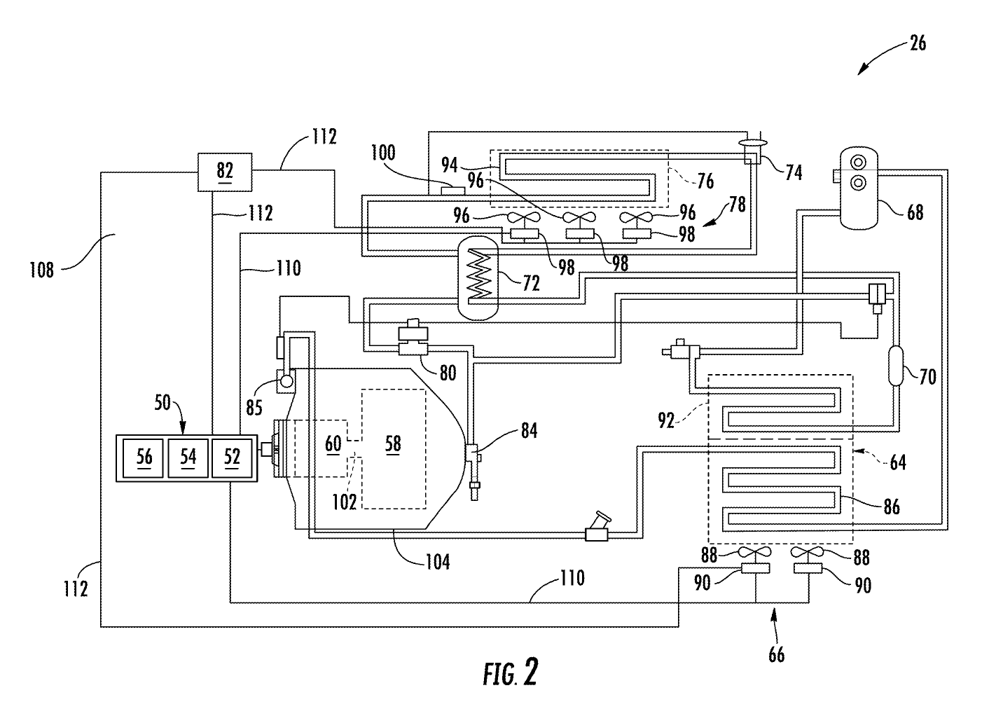

Referring to FIGS. 1 and 2, the transport refrigeration unit 26 may be a hybrid transport refrigeration unit 26, and may include a compressor 58, an electric compressor motor 60, a condenser heat exchanger 64 that may be air cooled, a condenser fan assembly 66, a receiver 68, a filter dryer 70, a heat exchanger 72, a thermostatic expansion valve 74, an evaporator heat exchanger 76, an evaporator fan assembly 78, a suction modulation valve 80, and a controller 82 that may include a computer-based processor (e.g., microprocessor). Operation of the transport refrigeration unit 26 may best be understood by starting at the compressor 58, where the suction gas (e.g., refrigerant) enters the compressor at a suction port 84 and is compressed to a higher temperature and pressure. The refrigerant gas is emitted from the compressor 58 at an outlet port 85 and may then flow into tube(s) 86 of the condenser heat exchanger 64.

Air flowing across a plurality of condenser coil fins (not shown) and the tubes 86, cools the gas to a saturation temperature. The air flow across the condenser heat exchanger 64 may be facilitated by one or more fans 88 of the condenser fan assembly 66. The condenser fans 88 may be driven by respective condenser fan motors 90 of the fan assembly 66 that may be electric and may be variable speed.

By removing latent heat, the gas within the tubes 86 condenses to a high pressure and high temperature liquid and flows to the receiver 68 that provides storage for excess liquid refrigerant during low temperature operation. From the receiver 68, the liquid refrigerant may pass through a subcooler heat exchanger 92 of the condenser heat exchanger 64, through the filter-dryer 70 that keeps the refrigerant clean and dry, then to the heat exchanger 72 that increases the refrigerant subcooling, and finally to the thermostatic expansion valve 74.

As the liquid refrigerant passes through the orifices of the expansion valve 74, some of the liquid vaporizes into a gas (i.e., flash gas). Return air from the refrigerated space (i.e., cargo compartment 40) flows over the heat transfer surface of the evaporator heat exchanger 76. As the refrigerant flows through a plurality of tubes 94 of the evaporator heat exchanger 76, the remaining liquid refrigerant absorbs heat from the return air, and in so doing, is vaporized.

The evaporator fan assembly 78 includes one or more evaporator fans 96, which may be driven by respective fan motors 98 that may be electric and may be variable speed. The air flow across the evaporator heat exchanger 76 is facilitated by the evaporator fans 96. From the evaporator heat exchanger 76, the refrigerant, in vapor form, may then flow through the suction modulation valve 80, and back to the compressor 58. A thermostatic expansion valve bulb sensor 100 may be located proximate to an outlet of the evaporator tube 94. The bulb sensor 100 is intended to control the thermostatic expansion valve 74, thereby controlling refrigerant superheat at an outlet of the evaporator tube 94. It is further contemplated and understood that the above generally describes a single stage vapor compression system that may be used for any type of refrigerant including natural refrigerants such as propane and ammonia. Other refrigerant systems may also be applied that use carbon dioxide (CO2) refrigerant, and that may be a two-stage vapor compression system.

A bypass valve (not shown) may facilitate the flash gas of the refrigerant to bypass the evaporator heat exchanger 76. This will allow the evaporator coil to be filled with liquid and completely ‘wetted’ to improve heat transfer efficiency. With CO2 refrigerant, this bypass flash gas may be re-introduced into a mid-stage of a two-stage compressor.

The compressor 58 and the compressor motor 60 may be linked via an interconnecting drive shaft 102. The compressor 58, the compressor motor 60 and the drive shaft 102 may all be sealed within a common housing 104. In some embodiments, the compressor motor 60 may be positioned outside of the compressor housing 104, and therefore the interconnecting drive shaft 102 may pass through a shaft seal located in the compressor housing. The compressor 58 may be a single compressor. The single compressor may be a two-stage compressor, a scroll-type compressor or other compressors adapted to compress natural refrigerants. The natural refrigerant may be CO2, propane, ammonia, or any other natural refrigerant that may include a global-warming potential (GWP) of about one (1).

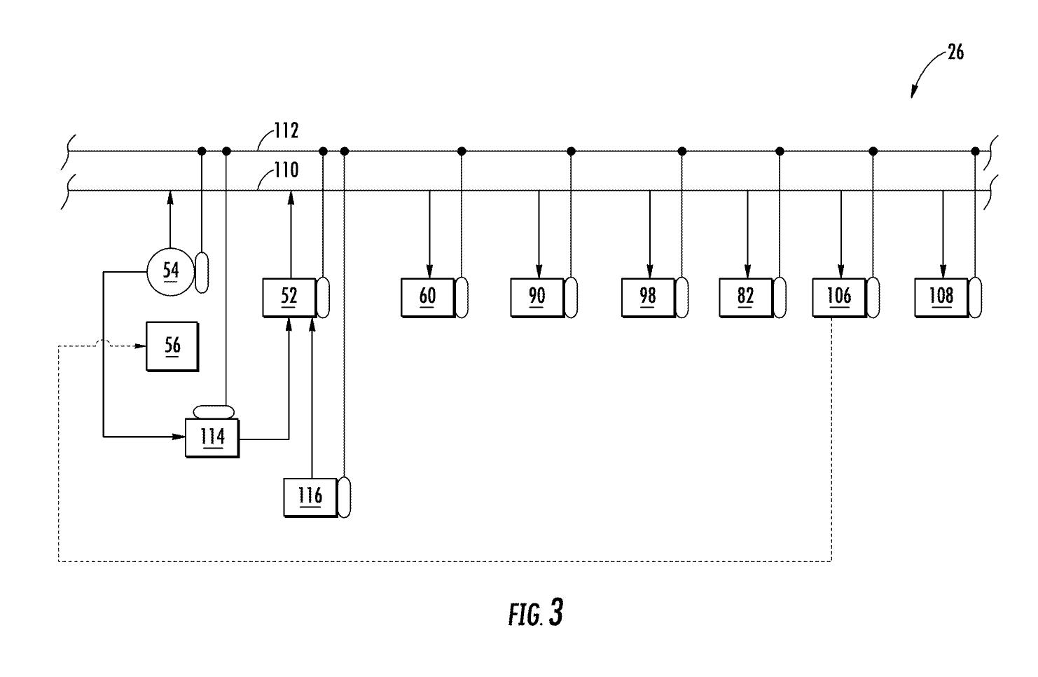

Referring to FIGS. 2 and 3, the transport refrigeration unit 26 further includes a multiple energy source 50 configured to selectively power (i.e., directly or indirectly) multiple components of the transport refrigeration unit 26 that may include the compressor motor 60, the condenser fan motors 90, the evaporator fan motors 98, the controller 82, a starter 106 of the combustion engine 56, and other components 108 that may include various solenoids and/or sensors. The electric power may be transferred over various buses, electrical devices and/or electrical conductors 110. The multiple energy source 50 may include an energy storage device 52, and a generator 54 mechanically driven by a combustion engine 56 that may be part of, and dedicated to, the transport refrigeration unit 26. The energy storage device 52 may be at least one battery and/or battery bank. In one embodiment, the energy storage device 52 may be secured to the underside of the bottom wall 32 of the trailer 24 (see FIG. 1). It is further contemplated and understood that other examples of the energy storage device 52 may include fuel cells, and other devices capable of storing and outputting electric power.

Referring to FIGS. 2 and 3, power management relative to the multiple energy source 50 and controlled power distribution relative to the various power loads (i.e., components) may be configured to minimize the size of the combustion engine 56 and minimize fossil fuel consumption while still providing enough electric power to meet temperature pulldown demands of the operating transport refrigeration unit 26. The controller 82 through a series of data and command signals over various pathways 112 may, for example, control the electric motors 60, 90, 98 and other components as dictated by the cooling needs of the refrigeration unit 26. The controller 82 may further control the electric power output of the generator 54 and the batteries 52 in order to meet the varying load demands of transport refrigeration unit 26.

In one example, the generator 54 and the energy storage device 52 may be electrically arranged in series. The electric power may be generally distributed through the bus 110, and may be direct current (DC). A converter (not shown) may be arranged at the outlet of the generator 54. The fan motors 90, 98 may be DC or alternating current (AC) motors, and the compressor motor 60 may be a DC motor, or AC motor with an inverter (not shown) at the power input to the motor 60. In one example, the generator 54 may have a maximum power output of about 15 kW, the energy storage device 52 may output electric power at about 10 kW, the steady state compressor motor 60 load may be about 10 kW, and the evaporator fan motor 98 and condenser fan motor 90 load may be about 2 kW. It is further contemplated and understood that various power conditioning devices may be configured throughout the transport refrigeration unit 26 depending upon the current type and voltage demands of any particular component.

In one embodiment, the generator 54 may be configured or downsized to provide substantially all of the electric power demands of the transport refrigeration unit 26 including the motors 60, 90, 98 during standard set point conditions (i.e., steady state conditions). However, when the transport refrigeration unit 26 is operating in a temperature pulldown state, the energy storage device 52 is available as a ‘battery boost’ to increase or supplement the DC power through the bus 110 thereby satisfying the temporary increase in power demand of, for example, the compressor motor 60. In this embodiment, the voltage potential of the energy storage device 52 may be about 5 kW to 7 kW.

In another embodiment, the energy storage device 52 may be configured to provide substantially all of the electric power demands of the transport refrigeration unit 26 including the motors 60, 90, 98 during standard set point conditions (i.e., steady state conditions). However, when the transport refrigeration unit 26 is operating in a temperature pulldown state, the generator 54 is available as a ‘battery boost’ to increase or supplement the DC power through the bus 110 thereby satisfying the temporary increase or surge in power demand of, for example, the compressor motor 60. In this embodiment, the voltage potential of the energy storage device 52 may be about 15 kW.

The transport refrigeration unit 26 may further include an energy storage device charger 114 (e.g., battery charger) and a renewable energy source 116 (e.g., solar panels). The battery charger 114 may be powered by the generator 54 during part-load operating conditions of the transport refrigeration unit 26 (i.e., partial compressor load conditions). The battery charger 114 may be controlled by the controller 82 and may be configured to charge the energy storage device 52 when needed and during ideal operating conditions. By charging the energy storage device 52 during reduced compressor load conditions, the size and weight of the generator 54 and driving engine 56 may be minimized. The renewable energy source 116 may be configured to charge the energy storage device 52 as needed and regardless of the operating state of the transport refrigeration unit 26. The renewable energy source 116 may facilitate the charging function through the charger 114, through a dedicated charger (not shown), or directly.

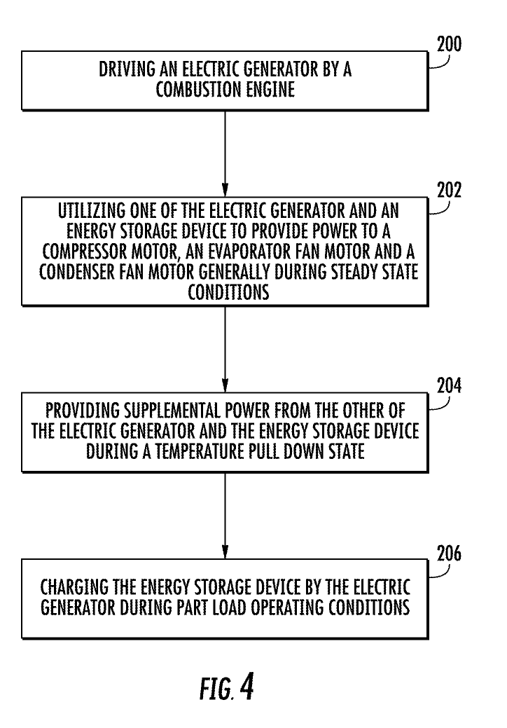

Referring to FIG. 4, a method of operating the transport refrigeration unit 26 may include a first block 200 of driving the electric generator 54 by the combustion engine 56. In block 202, the transport refrigeration unit 26 may utilize one of the electric generator 54 and the energy storage device 52 to provide power to the compressor motor 60, the evaporator fan motor 98, and the condenser fan motor 90 during steady state conditions. Per block 204, supplemental power may be provided by the other of the electric generator 54 and the energy storage device 52 during a temperature pull down state which may typically require more power than steady state conditions. In block 206, the energy storage device 52 may be recharged by the generator 54 during part load operating conditions of the transport refrigeration unit 26.

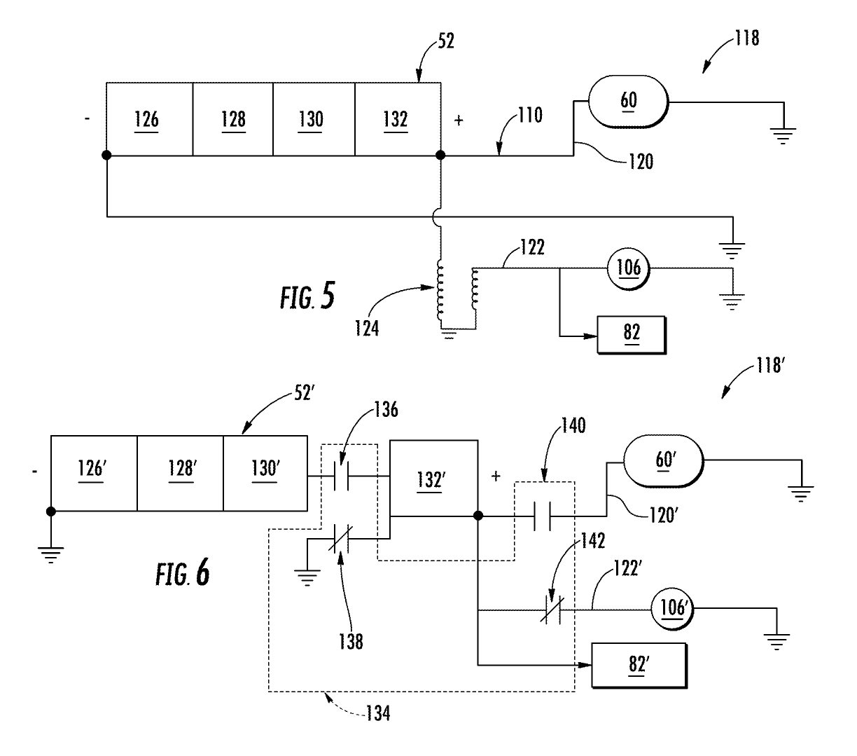

Referring to FIG. 5, a high voltage system 118 of the transport refrigeration unit 26 facilitates the controlled distribution of electrical power at varying voltages thereby reducing equipment and weight of more tradition transport refrigeration units. The high voltage system 118 may include the energy storage device 52 that may be a high voltage energy storage device, the generator 54 that may be a high voltage generator, the power distribution bus 110 that may include high voltage conductors 120 and low voltage conductors 122, and a step-down transformer 124 electrically orientated between the high voltage energy storage device 52 and the low voltage conductors 122. The high voltage energy storage device 52 may be a high voltage battery having a plurality of cells (four illustrated as 126, 128, 130, 132) with the cells 126, 128, 130, 132 configured in series to one-another. In one example, each cell 126, 128, 130, 132 may have a voltage potential of about twelve (12) volts with a total potential being about forty-eight (48) volts (i.e., the high voltage).

The high voltage conductor 120 electrically connects high voltage components of the transport refrigeration unit 26 to the high voltage battery 52. An example of a high voltage component may be the compressor motor 60. The step-down transformer 124 may be electrically connected between the high voltage battery 52 and/or high voltage conductor 120 and the low voltage conductor 122. As one example, the step down transformer 124 may reduce the voltage from about forty-eight (48) volts to about twelve (12) volts. In the present example, the low voltage conductor 122 may be adapted to carry twelve volts, and electrically connects low voltage components of the transport refrigeration unit 26 generally to the step-down transformer. Examples of low voltage components may include the controller 82 (e.g., microprocessor) and the engine starter 106. Although not illustrated, the starter 106 may include an electric motor and a starter contactor as is typically known in the art.

Utilization of the high voltage system 118 eliminates the need for a more traditional low voltage battery (e.g., twelve volt battery) dedicated to starting the combustion engine 56, and/or the need for a low voltage battery to power low voltage components of the transport refrigeration unit 26 when the engine is not in operation. More specifically, by the utilization of a high voltage battery 52 for hybrid operation of a transport refrigeration unit 26, the more traditional standby, low voltage, battery may be eliminated and the high voltage battery may be used in place of the low voltage battery for the same applications and purpose. By utilizing the step-down transformer 124, low voltage power (e.g., direct current) may be delivered from the high voltage batter 52 to the low voltage starter 106 and other low voltage components. When using the high voltage system 118, both high and low voltage, direct current, power may be continuously applied to both high and low voltage components.

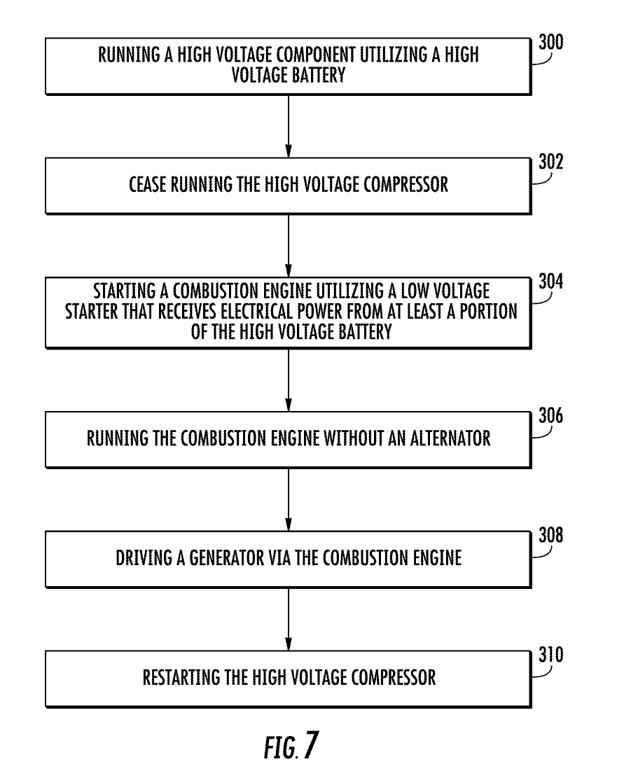

Referring to FIG. 6 a second embodiment of a high voltage system is illustrated wherein like elements to the first embodiment have like identifying numerals except with the addition of a prime suffix. A high voltage system 118′ may include a high voltage battery 52′ having a plurality of cells 126′, 128′, 130′, 132′, a power distribution bus 110′ that may include high voltage conductors 120′ and low voltage conductors 122′, and a relay 134. The relay 134 facilitates electrical isolation of, for example, the cell 132′ from the remaining cells 126′, 128′, 130′ of the high voltage battery 52′ to intermittently power low voltage components (e.g., starter 106′). The relay 134 may include a series of open/closed contactors 136, 138, 140, 142 for both switching between low and high voltage conductors 120′, 122′, and switching between low and high voltage cell arrangements of the battery 52′. In one example, contactors 136, 138 may be a battery voltage ground (BVG) contactors, and contactors 140, 142 may be battery voltage (BV) contactors. When low voltage is demanded, BVG contactor 136 oriented between cells 130′, 132′ is open, BVG contactor 138 oriented between cell 132′ and ground is closed, BV contactor 140 interposing the high voltage conductor 120′ is open, and BV contactor 142 interposing the low voltage conductor 122′ is closed. When high voltage is demanded, the contactors 136, 138, 140, 142 may switch between open and closed positions.

Unlike the high voltage system 118, the high voltage system 118′ may not supply both high and low voltage to the respective high and low voltage components at the same time (i.e., except for the low current, low voltage to the unit controller that may be always supplied). In the example of eliminating a dedicated low voltage battery for a standard low voltage starter 106, the high voltage system 118′ would generally shut down at least the compressor motor 60 and other high voltage components, when starting the combustion engine 56. Once started, the combustion engine 56 may drive the high voltage generator 54, and the high voltage components may be re-initialized. With the combustion engine 56 running when utilizing the high voltage system 118′, low voltage power is not supplied to the engine 56 (i.e., only during start-up). If the combustion engine 56 runs on gasoline, an alternator (not shown) may be needed to supply a spark to the spark plugs. If the combustion engine 56 is, for example, a diesel or natural gas engine, the conventional alternators used to recharge a low voltage battery are no longer required thus further reducing weight and cost.

Referring to FIG. 7, a method of operating a hybrid transport refrigeration unit 26 utilizing a high voltage system 118 is illustrated. At block 300 high voltage components such as a compressor motor 60 are running utilizing power from a high voltage battery. At block 302, the running of the high voltage compressor 60, and other high voltage components, may be terminated in preparation (for example) of segregating cells of the high voltage battery. At block 304, a combustion engine 56 is started utilizing a low voltage starter 106 that received low voltage power from at least a portion (e.g., one cell) of the high voltage battery 52. At block 306, the combustion engine 56 runs without use of an alternator. At block 308, a high voltage generator 54 is driven by the combustion engine. At block 310, the high voltage components (e.g., compressor motor) may be restarted.

Benefits of the present disclosure when compared to more traditional transport refrigeration units include lower fuel consumption, and a refrigeration unit that may emit less noise and may be lighter in weight. Yet further, the present disclosure includes an energy storage device that is conveniently and efficiently recharged to meet the power demands of the refrigeration unit while meeting combustion engine power and emission requirements that may be enforced by regulatory/government agencies. Further advantages include a transport refrigeration unit that includes a combustion engine and may not require a low voltage battery to start the engine, and may not require an alternator to sustain running of the engine and/or recharging of the low voltage battery that is no longer required.

While the present disclosure is described with reference to the figures, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A hybrid transport refrigeration unit comprising:
a high voltage battery including a plurality of cells;
at least one high voltage component electrically connected to the plurality of cells;
a generator configured to provide electric power to at least one of the at least one high voltage component;
a combustion engine constructed and arranged to drive the generator; and
a low voltage starter electrically connected to at least one of the plurality of cells, and constructed and arranged to start the combustion engine.

2. The hybrid transport refrigeration unit set forth in claim 1, wherein the combustion engine is a diesel engine.

3. The hybrid transport refrigeration unit set forth in claim 1, wherein the combustion engine is a natural gas engine.

4. The hybrid transport refrigeration unit set forth in claim 2, wherein the generator is a high voltage generator.

5. The hybrid transport refrigeration unit set forth in claim 4, wherein the combustion engine does not include a low voltage alternator.

6. The hybrid transport refrigeration unit set forth in claim 1, wherein the at least one high voltage component includes a variable speed condenser motor.

7. The hybrid transport refrigeration unit set forth in claim 1 further comprising:
a step-down transformer electrically oriented between the high voltage battery and the low voltage starter.

8. The hybrid transport refrigeration unit set forth in claim 1, wherein the high voltage battery has an electric potential of at least forty-eight (48) volts and the low voltage starter operates at about twelve (12) volts.

9. The hybrid transport refrigeration unit set forth in claim 1 further comprising:
a low voltage microprocessor for unit control.

10. The hybrid transport refrigeration unit set forth in claim 9, wherein the low voltage microprocessor is configured to determine when the combustion engine is started.

11. The hybrid transport refrigeration unit set forth in claim 1 further comprising:
a relay configured to electrically isolate the at least one of the plurality of cells from the remaining cells.

12. The hybrid transport refrigeration unit set forth in claim 11, wherein the at least one high voltage component is shut down when the combustion engine is being started via the low voltage starter.

13. The hybrid transport refrigeration unit set forth in claim 1 further comprising:
a solar panel configured to electrically charge at least the at least one of the plurality of cells.

14. The hybrid transport refrigeration unit set forth in claim 1, wherein the plurality of cells are electrically arranged in series.

15. The hybrid transport refrigeration unit set forth in claim 1 further comprising:
a compressor constructed and arranged to compress a refrigerant; and
an electric compressor motor being the at least one high voltage component and configured to drive the compressor, and wherein the generator is configured to provide high voltage electric power to the compressor motor during standard set point conditions and the high voltage battery is configured to supplement the high voltage electric power to the compressor motor during temperature pulldown conditions.

16. A high voltage system for a transport refrigeration unit having at least one high voltage component, at least one low voltage component, and a combustion engine, the high voltage system comprising:
a high voltage battery electrically connected to the at least one high voltage component and the at least one low voltage component; and
a high voltage generator configured to at least electrically charge the high voltage battery, and wherein the high voltage generator is driven by the combustion engine.

17. The high voltage system set forth in claim 16 further comprising:
a step-down transformer electrically oriented between the high voltage battery and the at least one low voltage component.

18. The high voltage system set forth in claim 16, wherein the high voltage battery includes first and second cells arranged in series.

19. The high voltage system set forth in claim 18 further comprising:
a series of open/closed contacts electrically orientated between the first and second cells, between the high voltage battery and the at least one high voltage component, and between the high voltage battery and the at least one low voltage component.

20. A method of operating a hybrid transport refrigeration unit comprising:
running a high voltage component utilizing a high voltage battery;
cease running the high voltage component;
starting a combustion engine utilizing a low voltage starter that receives electrical power from at least a portion of the high voltage battery;
running the combustion engine without an alternator;
driving a generator via the combustion engine; and
restarting the high voltage component.
